(19) United States
(12) Patent Application Publication
(10) Pub. No.: US 2002/0034196 A1
(43) Pub. Date: Mar. 21, 2002

(54) Systems and methods for transporting a network timing reference in an ADSL system

(76) Inventor: Marcos C. Tzannes, Orinda, CA (US)

Correspondence Address: NIXON PEABODY, LLP, 8180 GREENSBORO DRIVE, SUITE 800, MCLEAN, VA, 22102, US

(21) Appl. No.: 09/918,533

(22) Filed: Aug. 1, 2001

Related U.S. Application Data
(60) Provisional application No. 60/222,367, filed on Aug. 1, 2000.

(51) Int. Cl. H04J 3/00

(52) U.S. Cl. 370/529

(57) ABSTRACT

In a multicarrier modulation system, the NTR signal is inserted and transported at the modulation layer by sending the NTR bits, for example, as specified in the ADSL standard, on a set of carriers of a specified DMT symbol in a superframe. For example, the NTR bits can be sent on the first DMT symbol of the superframe. Thus, for the other DMT symbols in the superframe, the set of carriers used for transporting the NTR can be used to transport other data, such as information data.

### RELATED APPLICATION DATA

This application claims benefit of and priority to U.S. Provisional Application Ser. No. 60/222,367 filed Aug. 01, 2000 entitled “Transporting NTR with SRA”, and is related to U.S. application Ser. No. 09/522,870 filed Mar. 10, 2000 entitled “A Method for Seamlessly Changing Power Modes and ADSL Systems,” U.S. patent application Ser. No. 09/522,869, filed Mar. 10, 2000 entitled “Seamless Rate Adapted Adaptive Multicarrier Modulation System and Protocols,” and U.S. patent application Ser. No. 09/523,086, filed Mar. 10, 2000 entitled “A Method for Synchronizing Seamless Rate Adaptation,” all of which are incorporated herein by reference in their entirety

### BACKGROUND OF THE INVENTION

1. Field of the Invention

This invention generally relates to DSL systems. In particular, this invention relates to transporting a network timing reference for a DSL system.

2. Description of Related Art

Multi carrier modulation, or Discrete Multitone Modulation (DMT), is a transmission method that is being widely used for communication over media, and especially difficulty media. Multicarrier modulation divides the transmission frequency band into multiple subchannels, i.e., carriers, with each carrier individually modulating a bit or a collection of bits. A transmitter modulates an input data stream containing information bits with one or more carriers and transmits the modulated information. A receiver demodulates all of the carriers in order to recover the transmitted information bits as an output data stream.

Multicarrier modulation has many advantages over single carrier modulation. These advantages include, for example, a higher immunity to impulse noise, a lower complexity equalization requirement in the presence of a multipath, a higher immunity to narrow band interference, a higher data rate and bandwidth flexibility. Multicarrier modulation is being used in many applications to obtain these advantages, as well as for other reasons. The applications include, for example, Asymmetric Digital Subscriber Line (ADSL) systems, Wireless LAN systems, Power Line communications systems, and other applications. ITU standards G.992.1, G.992.2 and the ANSI T1.413 standard, each of which are incorporated herein by reference in their entirety, specify standard implementations for ADSL transceivers that use multicarrier modulation.

FIG. 1 illustrates an exemplary standard compliant ADSL DMT transmitter 100. In particular, the ADSL DMT transmitter 100 comprises three layers: the modulation layer 110, the Framer/Forward Error Correction (FEC) layer 120, and the ATM TC (Asynchronous Transfer Mode Transmission Convergence) layer 140.

The modulation layer 110 provides the functionality associated with DMT modulation. In particular, DMT modulation is implemented using an Inverse Discrete Fourier Transform (IDFT) 112. The IDFT 112 modulates bits from the Quadrature Amplitude Modulation (QAM) encoder 114 into the multicarrier subchannels. The ADSL multicarrier transceiver modulates a number of bits on each subchannel, the number of bits depending on the Signal to Noise Ration (SNR) of that subchannel and the Bit Error Rate (BER) requirement of the communications link. For example, if the required BER is 1×10⁻⁷, i.e., one bit in ten million is received in error on average, and the SNR of a particular subchannel is 21.5 dB, then that subchannel can modulate 4 bits, since 21.6 dB is the required SNR to transmit 4 QAM bits with a 1×10⁻⁷ BER. Other subchannels can have a different SNR's and therefore may have a different number of bits allocated to them at the same BER. The current ITU and ANSI ADSL standards allow up to 15 bits to be modulated on one carrier.

A table that specifies how many bits are allocated to each subchannel for modulation in one DMT symbol is called a Bit Allocation Table (BAT). A DMT symbol is the collection of analog samples generated at the output of the IDFT by modulating the carriers with bits according to the BAT. The BAT is the main parameter used in the modulation layer 110. The BAT is used by the QAM encoder 114 and the IDFT 112 for encoding and modulation. The following Table illustrates an example of a BAT for a DMT system having 16 subchannels.

TABLE 1

| Subchannel | Bits per |
|---|---|
| Number | Subchannel |
| 1 | 5 |
| 2 | 9 |
| 3 | 3 |
| 4 | 2 |
| 5 | 4 |
| 6 | 0 |
| 7 | 5 |
| 8 | 7 |
| 9 | 8 |
| 10 | 3 |
| 11 | 0 |
| 12 | 5 |
| 13 | 6 |
| 14 | 8 |
| 15 | 4 |
| 16 | 3 |
| Total Bits Per | 80 |
| DMT Symbol | |

In ADSL systems, the DMT symbol rate is approximately 4 kHz. This means that a new DMT symbol modulating a new set of bits, using the modulation BAT, is transmitted every 250 microseconds. If the BAT in Table 1, which specifies 80 bits modulated in one DMT symbol, were used at a 4 kHz DMT symbol rate, the bit rate of the system would be 4000* 80=320 kbits per second (kbps). The BAT determines the data rate of the system and is dependent on the transmission channel characteristics, i.e., the SNR of each subchannel in the multicarrier system. A channel with low noise, i.e., a high SNR on each subchannel, will have many bits modulated on each DMT carrier and will thus have a high bit rate. If the channel conditions are poor, e.g., high noise, the SNR will be low and the bits modulated on each carrier will be few, resulting in a low system bit rate As can be seen in Table 1, some subchannels may actually modulate zero bits. An example is the case when a narrow band interferer, such as an AM broadcast, is present at a subchannel's frequency and causes the SNR in that subchannel to be too low to carry any information bits.

The ATM TC layer 140 comprises an Asynchronous Transfer Mode Transmission Convergence (ATM TC) section 142 that transforms bits and bytes in cells into frames.

The Framer/FEC layer 120 provides the functionality associated with preparing a stream of bits for modulation. The Framer/FEC layer 120 comprises an Interleaving (INT) portion 122, a Forward Error Correction (FEC) portion 124, a scrambler (SCR) portion 126, a Cyclic Redundancy Check (CRC) portion 128 and an ADSL Framer portion 130. The Interleaving and FEC coding provide an impulse immunity and a coding gain. The FEC portion 124 in the standard ADSL system is a Reed-Solomon (R-S) code. The scrambler 126 is used to randomize the data bits. The CRC portion 128 is used to provide error detection at the receiver. The ADSL Framer portion 130 frames the received bits from the ATM framer 142. The ADSL framer 130 also inserts and extracts overhead bits from the module 132 for modem to modem overhead communication channels, which are known as EOC and AOC channels in the ADSL standards.

The key parameters of the Framer/FEC layer 120 are the size of the R-S codeword, the size, i.e., depth, of the interleaver, which is measured in the number of R-S codewords, and the size of the ADSL frame. As an example, a typical size for an R-S codeword may be 216 bytes, a typical size for interleaver depth may be 64 codewords, and a typical size of the ADSL frame may be 200 bytes. It is also possible to have an interleaving depth equal to one, which is equivalent to no interleaving. In order to recover the digital signal that was originally prepared for transmission using a transmitter as discussed above, it is necessary to deinterleave the codewords by using a deinterleaver that performs the inverse process to that of the interleaver, with the same depth parameter. In the current ADSL standards, there is a specific relationship between all of these parameters in a DMT system. Specifically, the BAT size, N_{BAT}, i.e., the total number of bits in a DMT symbol, is fixed to be an integer divisor of the R-S codeword size, N_{FEC}, as expressed in equation 1:

N_{FEC}=S*N_{BAT}, (1)

where S is a positive integer greater than 0.

This constant can also be expressed as one R-S codeword containing an integer number of DMT symbols. The R-S codeword contains data bytes and parity, i.e, checkbytes. The checkbytes are overhead bytes that are added by the R-S encoder and are used by the R-S decoder to detect and correct bit errors. There are R checkbytes in a R-S codeword. Typically, the number of checkbytes is a small percentage of the overall codeword size, e.g., 8%. Most channel coding methods are characterized by their coding gain, which is defined as the system performance improvement, in dB, provided by the code when compared to an uncoded system. The coding gain of the R-S codeword depends on the number of checkbytes and the R-S codeword size. A large R-S codeword, e.g., greater than 200 bytes in a DMT ADSL system, along with 16 checkbytes, i.e., 8% of the 200 bytes, will provide close to the maximum coding gain of 4 dB. If the codeword size is smaller and/or the percentage of checkbyte overhead is high, e.g., greater than 30%, the coding gain may be very small or even negative. In general, it is best to have the ADSL system operating with the largest possible R-S codeword, with the current maximum being 255 bytes, and approximately 8% redundancy.

There is also a specific relationship between the number of bytes in an ADSL frame, N_{FRAME}, and the R-S codeword size, N_{FEC} that is expressed in equation (2):

N_{FEC}=S×N_{FRAME}+R, (2)

where R is the number of R-S checkbytes in a codeword and S is the same positive integer as in Equation (1).

It is apparent from equating the right-hand sides of Equations (1) and (2) that the relationship expressed in equation (3) results in:

N_{BAT}=N_{FRAME}+R/S. (3)

The current ADSL standard requires that the ratio (R/S) is an integer, i.e. there is an integer number of R-S checkbytes in every DMT-symbol (N_{BAT}). As described above, ADSL frames contain overhead bytes, which are not part of the payload, that are used for modem to modem communications. A byte in an ADSL frame that is used for the overhead channel cannot be used for the actual user data communication, and therefore the user data rate decreases accordingly. The information content and format of these channels is described in the ITU and ANSI standards. There are several framing modes defined in ADSL standards. Depending on the framing mode, the number of overhead bytes in one ADSL frame varies. For example, standard Framing Mode 3 has 1 overhead byte per ADSL frame.

Equations (1), (2) and (3) demonstrate that the parameter restrictions imposed by the standards result in the following conditions:

1. All DMT symbols have a fixed number of overhead framing bytes that are added at the ADSL framer. For example, in Framing Mode #3, there is 1 overhead framing byte per DMT symbol.

2. There is a minimum of one R-S checkbyte per DMT symbol.

3. The maximum number of checkbytes according to ITU Standard G.992.2 (8) and ITU Standards G.992.2 and T1.413 (16) limits the maximum codeword size to 8* N_{BAT} for G.992.2, and to 16* N_{BAT} for G.992.1 and T1.413.

4. An ADSL modem cannot change the number of bits in a DMT symbol (N_{BAT}) without making the appropriate changes to the number of bytes in a R-S codeword (N_{FEC}) and an ADSL frame (N_{FRAME}).

The above four restrictions cause performance limitations in current ADSL systems. In particular, because of condition 1, every DMT symbol has a fixed number of overhead framing bytes. This is a problem when the data rate is low and the overhead framing bytes consume a large percentage of the possible throughput, which results in a lower payload.

For example, if the date rate supported by the line is 6.144 Mbps, this will result in a DMT symbol with about 192 bytes per symbol (192*8*4000=6144 kbps). In this case, one overhead framing byte would consume 1/192 or about 0.5% of the available throughout. But if the date rate is 128 kbps, or 4 bytes per symbol, the overhead framing byte will consume ¼ or 25% of the available throughput. Clearly this is undesirable.

Condition 2 will cause the same problems as condition 1. In this case, the overhead framing byte is replaced by the R-S checkbyte.

Condition 3 will not allow the construction of large codewords when the data rate is low. The R-S codewords in ADSL can have a maximum of 255 bytes. The maximum coding -gain is achieved when the codeword size is near the maximum 255 bytes. When the data rate is low, e.g., 128 kbps or 4 bytes per symbol, the maximum codeword size will be 8*4=32 bytes for G.992.2 systems and 16*4=64 bytes for G.992.1 and T1.413 systems. In this case the coding gain will be substantially lower than for large codewords approaching 255 bytes.

In general, if the data rate is low, e.g., 128 kbps or 4 bytes per symbol, the above conditions will result in 1 byte being used for overhead framing, and 1 byte being consumed by an R-S checkbyte. Therefore 50% of the available throughput will not be used for payload and the R-S codeword size will be at most 64 bytes, resulting in negligible coding gain.

Condition 4 effects the ability of the modem to adapt its transmission parameters on-line in a dynamic manner.

G.992.1 and T1.413 specify a mechanism to do on-line rate adaptation, called Dynamic Rate Adaptation (DRA), but it is clearly stated in these standards that the change in data rate will not be seamless. In general, current ADSL DMT modems use Bit Swapping and dynamic rate adaptation (DRA) as methods for on-line adaptation to channel changes. Bit swapping is specified in the ITU and ANSI standards as a method for modifying the number of bits allocated to a particular carrier. Bit Swapping is seamless, i.e., it does not result in an interruption in data transmission and reception, however, Bit Swapping does not allow the changing of data rates. Bit Swapping only allows the changing the number of bits allocated to carriers while maintaining the same data rate. This is equivalent to changing the entries in the BAT table without allowing the total number of bits (N_{BAT}) in the BAT to increase or decrease.

DRA enables a change in data rate, but is not seamless. DRA is also very slow because it requires the modem located in the Central Office (CO) to make the final decision on the data rate configuration. This model, where the CO being the master, is common among ADSL modems that are designed to provide a service offered and controller by the telephone company.

Both Bit Swapping and DRA use a specific protocol that is specified in the ANSI T1.413, G.992.1 and G.992.2 standards for negotiating the change. This protocol negotiates the parameters using messages that are sent via an AOC channel, which is an embedded channel. This protocol is sensitive to impulse noise and high noise levels. If the messages are corrupted the transmitter and receiver can enter a state where they are using different transmission parameters, e.g., BAT, data rate, R-S codeword length, interleaver depth, etc. When two communicating modems enter a state of mismatched transmission parameters, data will be received in error and the modems will eventually be required to take drastic measures, such as full re-initialization, in order to restore error free transmission. Drastic measures such as full reinitialization will result in the service being dropped for approximately 10 seconds, which is the time required for the current standards compliant ADSL modem to complete a full initialization.

A transceiver has both a transmitter and a receiver. The receiver includes the receiver equivalent blocks of the transmitter as shown in FIG. 1. The receiver has modules that include a decoder, a deinterleaver and a demodulator. In operation, the receiver accepts a signal in analog forms that was transmitted by a transmitter, optionally amplifies the signal in an amplifier, filters the signal to remove noise components and to separate the signal from other frequencies, converts the analog signal to a digital signal through the use of an analog to digital converter, demodulates the signal to generate the received bit stream from the carrier subchannels by the use of a demodulator, deinterleaves the bit stream by the use of a deinterleaver, performs the FEC decoding to correct errors in the bit stream by use of an FEC decoder, descrambles the bit stream by use of a descrambler, and detects bit errors in the bit stream by use of a CRC. Various semiconductor chip manufacturers supply hardware and software that can perform the functions of a transmitter, a receiver, or both.

### SUMMARY OF THE INVENTION

According to an exemplary embodiment of the invention, ADSL DMT systems and methods are provided that change transmission bit rates in a seamless manner during operation. The ADSL DMT systems and methods operate according to protocols that allow the seamless change of transmission bit rates during operation to be initiated by either the transmitter or the receiver. The ADSL DMT systems and methods discussed herein also provide for seamless changes of transmission bit rates during operation and the transportation of a network timing reference (NTR).

The transporting of an NTR requires sending a timing reference signal from the CO modem to the CPE modem that enables a CPE modem to reconstruct the network clock in order to, for example, send or receive signals or applications that are synchronous to the network clock, such as voice over DSL. As discussed hereinafter, the seamless rate adaptation system allows for the framing layer to be decoupled from the modulation layer. As a result, the NTR signal cannot be inserted into the framing layer as it is done in the current ADSL standards in the ITU and ANSI.

For example, the NTR signal can be inserted and transported in the modulation layer by sending the NTR bits on a set of carriers or on a specified DMT symbol in a superframe. On the other DMT symbols in the superframe, the set of carriers used for transporting the NTR are used to transport other information.

Accordingly, and in accordance with an exemplary embodiment of this invention, a first aspect of the invention relates to transporting a network timing reference.

Aspects of the invention also relate to inserting and transporting an NTR signal in a modulation layer.

Aspects of the invention also relate to inserting and transporting an NTR signal in a modulation layer by sending the NTR bits on a set of carriers to a specified DMT symbol in a superframe.

Aspects of the invention also relate to using different bit allocation tables based on whether NTR bits are provided in the DMT symbol.

These and other features and advantages of this invention are described in, or are apparent from, the following detailed description of the embodiments.

### BRIEF DESCRIPTION OF THE DRAWINGS

The embodiments of the invention will be described in detail, with reference to the following figures wherein:

FIG. 1 is a functional block diagram illustrating a standard compliant ADSL DMT transmitter;

FIG. 2 illustrates an exemplary embodiment of an ADSL frame and R-S codewords;

FIG. 3 is a functional block diagram illustrating an exemplary dual latency ADSL DMT transmitter;

FIG. 4 is a flowchart outlining an exemplary method of a seamless rate adaptive transmission;

FIG. 5 is a flowchart outlining a second exemplary method of seamless rate adaptive transmissions;

FIG. 6 is a flowchart outlining an exemplary method of fast seamless rate adaptive transmissions;

FIG. 7 is a flowchart outlining a second exemplary method of fast seamless rate adaptive transmission; and

FIG. 8 is flowchart illustrating an exemplary method of transporting a NTR.

### DETAILED DESCRIPTION OF THE INVENTION

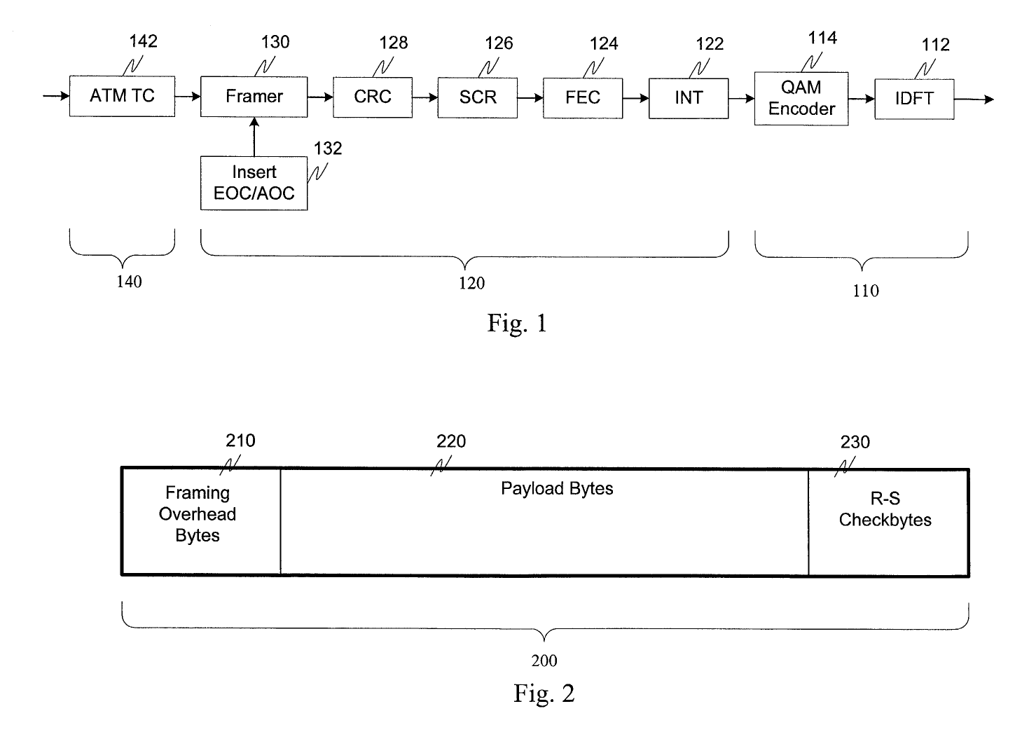

The principles of the invention may be employed using transceivers that include a transmitter, such as that discussed above in relation to FIG. 1, and a receiver. In general, an ADSL system includes both a transmitter and a receiver for communication in a particular direction. In the discussion that follows, an ADSL DMT transmitter accepts digital input and transmits analog output over a transmission line, which can be, for example, a twisted wire pair, or the like. A transmission can also occur over a medium that includes other kinds of wires, fiber optic cable, wireless links, or the like. In order to utilize the transmitted signal, a second transceiver at the remote end of the transmission line includes a receiver that converts the received analog signal into a digital data stream for use by devices, such as computers, digital televisions, digital radios, communications equipment, or the like. For bidirectional communication using a pair of transceivers, each transceiver includes a transmitter that sends information to the receiver of the other member of the pair, and a receiver that accepts information transmitted by the transmitter of the other member of the pair.

As discussed herein, the exemplary DMT system has the capability of adapting the system bit rate on-line in a seamless manner. The DMT system also provides a robust and fast protocol for completing this seamless rate adaptation. The DMT system also provides a framing and encoding method with reduced overhead compared to conventional DMT systems. This framing and encoding method enables, for example, a system with a seamless rate adaptation capability.

It may be desirable to change the modem data rate after training due to a change in, for example, channel characteristics or, for example, because an application running over the ADSL communication link has changed. Examples of changing channel characteristics include, for example, changes in noise on the line, changes in the cross-talk from other services in the bundle, or on the same line, changes in the levels and the presence of radio frequency interference, changes in the line impedance due to, for example, temperature changes, changes in the state of equipment on the line, e.g., a phone going from on-hook to off-hook, or vice versa, and the like. Examples of changes in applications include, for example, power down modes for a PC, a user changing from internet browsing to two-way video conferencing, a user changing from internet browsing to voice over DSL with or without internet browsing, and the like. Because of one or more of these characteristics, it is often desirable or required to change the data rate of the modem. It is highly desirable that this data rate change occurs in a “seamless” manner, i.e., without data bit errors or an interruption in service. However, the DMT ADSL modem specified standards are not capable of performing seamless data rate adaptation.

Condition 4 described above does not allow the size of the BAT to change without modifying the R-S coding, interleaving and framing parameters. If the BAT and N_{BAT} could be modified during operation, i.e., if more or fewer bits were allocated to carriers in a DMT symbol, the data rate could be changed. Condition 4 requires that when the number of bits N_{BAT} in the BAT changes, the size of the R-S codeword, and therefore the interleaving parameters, must also be modified. Modifying the interleaving and coding parameters on-line requires the re-initialization of the interleaver. Re-initialization of the interleaver always results in a “flushing” of the interleave memory. This flushing of the memory results in data errors and the transition not being seamless.

In order to allow a DMT ADSL transmission system to change the data rate seamlessly, the framing and encoding of the data must be efficient such that there is less overhead data bits per DMT symbol which thereby increases the user bit rate. Additionally, the ADSL system must be able to dynamically adapt to the data rate on-line, e.g., during operation, in a seamless manner. Furthermore, there must exist a robust and fast protocol for completing such a seamless rate adaptation such that the data rate change can occur successfully even in the presence of high noise levels.

As discussed hereinafter, and in the co-pending related applications, an exemplary framing method is disclosed that decreases the overhead, i.e., non-payload data in a DMT ADSL system.

FIG. 2 illustrates an ADSL frame and R-S codeword 200 that comprises at least one framing overhead byte 210, one or more payload bytes 220 and one or more checkbytes 230. This framing method enables seamless rate adaptation. As discussed above, current ADSL systems place restrictions and requirements on the ADSL frames, R-S codewords, and DMT symbols. This configuration allows for the de-coupling of the ADSL frames and the R-S codewords from the DMT symbols. This de-coupling results in a system that has, for example, lower overhead data per DMT symbol and can also complete an on-line rate adaptations in a seamless manner. Thus, the ADSL frames and the R-S codewords are constructed to have the same length and to be aligned. The R-S codeword is made sufficiently large to maximize the coding gain. The size of the R-S codeword, and therefore the ADSL frame, can be negotiated at, for example, start-up or determined in advance. A fixed number of R-S checkbytes and overhead framing bytes are included in an ADSL frame. These parameters can also be negotiated at start-up or determined in advance.

Unlike conventional DMT symbols, the DMT symbols produced in accordance with the exemplary embodiment of this invention are not aligned with the ADSL frames and the R-S codewords. Additionally, the number of bits in a DMT symbol depends solely on the data rate requirements and configurations, and is de-coupled from the R-S codeword size, the interleaver depth, and the ADSL frame size.

The number of bits in a DMT symbol dictates the data rate of the modem independently of the other framing, coding or interleaving restrictions. Since overhead bytes are added at the ADSL frame layer, a DMT symbol does not necessarily contain a fixed number of overhead bytes. As the data rate gets lower, for example, 128 kbps, the overhead data remains low. In particular, this framing method assigns a fixed percentage of overhead data to the data stream, rather than a fixed number of overhead bytes. This percentage does not change when the data rate of the modem changes, as in the case with current ADSL modems. Consider the following examples of conventional standard compliant framing methods:

### CONVENTIONAL EXAMPLE #1

The line capacity is 192 bytes per DMT symbol (6.144 Mbps). The codeword size is 192, which includes 16 checkbytes and one overhead framing byte, assuming ANSI T1.413 Framing Mode No. 3. The total framing overhead, i.e., checkbytes plus overhead framing bytes, per DMT symbol is 16+1=17. Therefore, the framing overhead is 17/192=8.8% of the available throughput. In this case, the framing overhead is reasonable.

### CONVENTIONAL EXAMPLE #2

The line capacity is 4 bytes (128 kbps). The codeword is constructed from 16 DMT symbols and is 16×4=64 bytes. There are 16 R-S checkbytes, one checkbyte per DMT symbol, and there is one overhead framing byte, assuming ANSI T1.413 Framing Mode No. 3. The total framing overhead, i.e., checkbytes plus overhead framing bytes, per DMT symbol is 1+1=2 bytes. Therefore the framing overhead is 2/4=50% of the available throughput. This is highly inefficient.

Examples of embodiments of the framing method of this invention provide the following results, called the constant percentage overhead method:

### EXAMPLE #1

This is exactly the same as the standard compliant training example, i.e., conventional example #1 above. The codeword sizes, DMT symbol sizes and overhead are the same. Therefore, the framing overhead is 17/192=8.8% of the available throughput.

### EXAMPLE #2

The line capacity is 4 bytes (128 kbps). The codeword is constructed independently of the DMT symbol and therefore could be, for example, set to 192 bytes. This is also the size of the ADSL frame. Sixteen R-S bytes and one overhead framing byte per codeword or ADSL frame are used. There are 192/4=48 DMT symbols in one codeword. The total overhead, i.e., checkbytes plus overhead framing bytes, per 48 DMT symbols is 1+16=17 bytes or 17/48=0.35 bytes per one DMT symbol. The framing overhead is thus 0.35/4=8.8% of the available throughout.

Accordingly, from Examples 1 and 2 above, it is apparent that the principles of this invention at least provide a method of achieving a framing overhead that is a constant percentage of the available throughput, regardless of the data rate or the line capacity. In these exemplary scenarios, the framing overhead was 8.8% for both 6 Mbps and 128 kbps.

Another exemplary benefit of the framing method described herein is that it enables seamless on-line rate adaptation. Seamless rate adaptation (SRA) is accomplished by changing the DMT symbol BAT, i.e., the number of bits allocated to each subchannel in the multicarrier system. As shown above, modifying the BAT changes the number of bits per DMT symbol and results in a change in the data bit rate of the system. In an exemplary embodiment, the DMT symbol size is changed without modifying any of the R-S coding, interleaving and/or framing parameters. This is possible because the constant percentage overhead framing method described above removes the restrictions imposed by the prior art on the relation between the DMT symbols and the R-S codewords or ADSL frames. Since the R-S coding and interleaving parameters do not change, interleaver flushing and other problems associated with changing the parameters associated with these functions do not occur. Thus, the transceiver can adapt the data rate without errors or service interruption through an updating of the BAT.

A BAT should be updated at the transmitter and the receiver at exactly the same time, i.e., on exactly the same DMT symbol. If the transmitter starts using a new BAT for transmission before the receiver does, the data is not demodulated correctly and bit errors can occur. Also, if the receiver changes to a new BAT before the transmitter does, the same errors can occur. For this reason, the transition to the use of the updated BAT for transmission and reception needs to be synchronized at the transmitter and the receiver. In an exemplary embodiment, a protocol is provided that enables the synchronized transition to the use of an updated BAT.

It is also important that, for example, this protocol be robust in the presence of channel noise. For example, if the protocol fails and the receiver does not switch to the updated BAT at the same time as the transmitter, then bit errors occur and the transition is not seamless. Furthermore, if the transmitter and receiver are using different BATs, it is difficult to re-establish an error-free link without performing a re-initialization of the connection, which results in an interruption of service of up to, for example, ten or more seconds.

It is also important that the transition between the BATs occur very quickly, since the need to operate at a new data rate is usually instantaneous. As an example, at a constant data rate, a sudden decrease in the channel SNR will increase the number of bits received in error. A change in the data rate is required because of the reception of many bits in error. In this situation, it is desirable to change the data rate as soon as possible to switch out of the state of receiving bits in error. As an example, a change in the application being transported over the ADSL link can require a change in the data rate. For example, if one user is browsing the internet and then another user wishes to make a voice call over the flow of data bits using the voice over DSL capability of the ADSL connection, it is necessary to quickly change the data rate of the system to accommodate the telephone call in addition to the existing traffic.

Accordingly, the SRA protocol should at least provide a method for synchronizing the transmitter and receiver station to the updated BAT, a robust transition to the new data rate and a fast transition to the new data rate.

Two exemplary protocols are provided that satisfy these requirements for seamless rate adaptation. The first protocol is the normal SRA (NSRA) protocol and the second protocol is the fast SRA (FSRA) protocol.

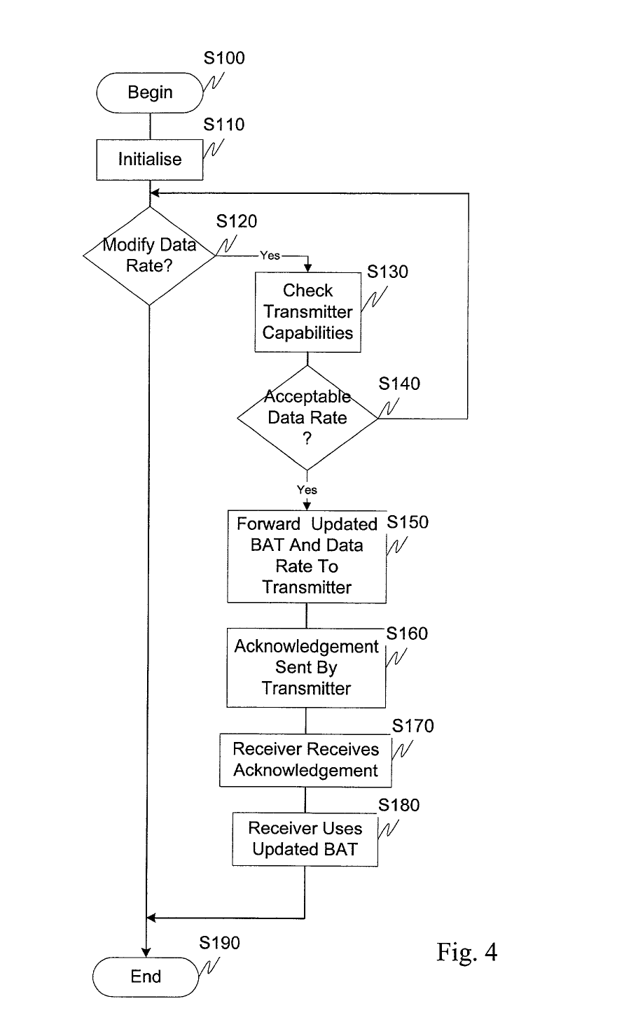

In the normal SRA protocol (NSRA), either the transmitter or the receiver can initiate this method as illustrated in FIGS. 4 -5. In particular, for receiver initiated SRA, control begins in step S100 and continues to step S110. In step S110, the system is initialized. In particular, the transmitter and receiver exchange, for example, information describing their maximum and minimum data rate capabilities. This corresponds to the maximum and minimum number of bits per DMT symbol. Next, in step S120, during operation, a receiver determines whether the data rate should be modified, i.e., increased or decreased. If the data rate is to be modified, control continues to step S130. Otherwise, control jumps to step S190, where the control sequence ends.

In step S130, the capabilities of the transmitter are checked based on the determined modified data rate. The data rate may be modified because, for example, the channel conditions have changed of the desired Bit Error Rate has changed. Then, in step S140, a determination is made whether the updated data rate is within the transmitter's rate capabilities. If the updated data rate is within the transmitter's capabilities, control continues to step S150. Otherwise, control jumps back to step S120.

In step S150, the updated BAT and data rate are forwarded to the transmitter using, for example, the AOC or EOC channel. This corresponds to an “NSRA Request” by the receiver. Next, in step S160, the transmitter receives the “NSRA Request” and uses an inverted synchronization (SYNC) symbol as a flag to signal the receiver that the updated BAT is going to be used. The updated BAT is used for transmission on the first frame, for a finite number of frames, following the inverted SYNC symbol. The inverted SYNC symbol operates as a rate adaptation “SRA GO” message sent by the transmitter. Then, in step S170, the receiver detects the inverted SYNC symbol, “SRA GO,” and the updated BAT is used for reception on the first frame, or for a finite number of frames, following the inverted SYNC symbol. Control then continues to step S190, where the control sequence ends.

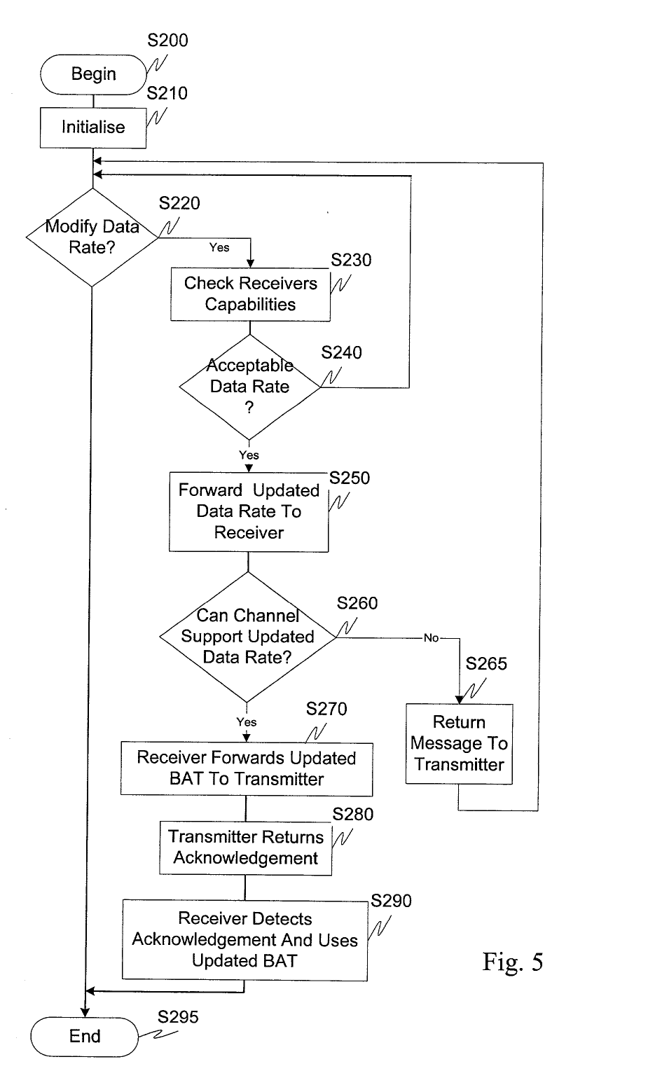

FIG. 5 illustrates the method of performing a transmitter-initiated NSRA In particular, control begins in step S200 and continues to step S210. In step S210, the system is initialized wherein the transmitter and the receiver exchange information describing, for example, their maximum and minimum capabilities regarding their data rate. This corresponds to the maximum and minimum number of bits per DMT symbol. Next, in step S220, during operation, the transmitter determines whether the data rate should be modified, i.e., increased or decreased. If the data rate is to be modified, control continues to step S230. Otherwise, control jumps to step S295 where the control sequence ends.

In step S230, having determined the modified data rate, the capabilities of the receiver are checked to determine if the desired data rate is within the receiver's rate capability. Next, in step S240, a determination is made whether the data rate is acceptable. If the data rate is acceptable, control continues to step S250. Otherwise, control jumps back to step S220.

In step S250, the transmitter forwards to the receiver the updated data rate using the EOC or AOC channel. This corresponds to an “NSRA Request” message. Next, in step S260, a determination is made, based on the NSRA request, whether the channel can support the new data rate. If the channel can support the new data rate, control continues to step S270. Otherwise, control jumps to step S265, where an “SRA DENY” message is sent back to the transmitter using, for example, the EOC or AOC channel.

In step S270, the receiver forwards the updated BAT to the transmitter using, for example, the AOC or EOC channel based on the updated data rate. This corresponds to an “NSRA GRANT” request by the receiver. Next, in step S280, the transmitter receives the “NSRA GRANT” message and uses an inverted SYNC symbol as a flag to signal the receiver that the new BAT is going to be used. This new BAT is used for transmission on the first frame, or a finite number of frames, following the inverted SYNC symbol. The inverted SYNC symbol operates as a rate adaptation “SRA GO” message sent by the transmitter. Then, in step S290, the receiver detects the inverted SYNC symbol “SRA GO” and the updated BAT is used for reception on the first frame, or for a finite number of frames, following the inverted SYNC symbol.

The rate adaptation involves changing the number of bits in a DMT symbol by changing the BAT, and not the R-S codeword size, interleaver depth, or the ADSL frame size. This can be done without any interruption in data flow or an introduction of data errors.

This protocol is, for example, faster than conventional rate adaptation methods because it does not require an extended handshake between the transmitter and the receiver in order to approve the new transmission parameters and rates. No extended handshake is needed because the data rate capabilities are known in advance and negotiated during the start-up period. Additionally, the other parameters, such as the R-S codeword length, the interleaver depth, etc., are not changed in conjunction with the data rate change.

Furthermore, this protocol is more robust than conventional rate adaptation techniques because, for example, it does not use the EOC or AOC channel to send the “SRA GO” message for synchronizing the transition to the new data rate. In conventional rate adaptation techniques, the messages sent over the EOC and AOC channel can easily become corrupted by noise on the line. These overhead channels are multiplex into the data stream at the framer and therefore submitted with Quadrature Amplitude Modulation over a finite number of DMT subchannels. Impulse noise or other noise that occurs on the line can easily cause bit errors in the AOC channel message, and the message can be lost. If the “SRA GO” message is corrupted and not received by the receiver, then the receiver does not know if the SRA request was granted. The transmitter, on the other hand, assumes the “SRA GO” message was received and switches to the new data rate and transmission parameters. The receiver, which did not receive the grant message, does not know when to switch to the new rate, and the modem becomes unsynchronized and data errors can occur.

With the above methods, and unlike conventional rate adaptation techniques, the “SRA GO” message is not sent via an EOC or AOC message that can easily be corrupted. Instead, the grant of the rate adaptation request is communicated via an inverted SYNC symbol. The SYNC symbol is defined in the ANSI and IT standards as a fixed non-data carrying DMT symbol that is transmitted every 69 symbols. The SYNC symbol is constructed by modulating all the DMT carriers with a predetermined PN sequence using basic QPSK (2-bit QAM modulation). This signal, which is used throughout the modem initialization process, has a special auto-correlation property that makes possible the detection of the SYNC symbol and the inverted SYNC symbol even in highly noisy environments. An inverted SYNC symbol is a SYNC symbol in which the phase information in the QAM signal is shifted by 180 degrees. However, phase shifts other than 180 degrees of the SYNC symbol can be used equally well for the “SRA GO” message. Using the SYNC symbol for the “SRA GO” message makes the rate adaptation protocol very robust, even in noisy environments. However, in general, any symbol that can be detected in the presence of noise can be used in place of the SYNC symbol.

The Fast SRA (FSRA) protocol seamilessly changes the data rate on the line faster than the NSRA protocol. This is important, for example, for applications that are activated and de-activated continuously over time or when sudden channel changes occur. In the FSRA protocol, stored BATs are used to speed up the SRA handshake and enable quick changes in the data rate. Unlike the profiles used in G.992.2, the stored BATs do not contain the R-S coding and interleaving parameters since these parameters are not affected when a data rate change occurs using the constant percentage overhead framing.

The BATs are exchanged using the NSRA method described in the previous section. After the one-time NSRA is complete, and a BAT that is based on the particular channel condition or application condition is stored by both transceivers, the FSRA protocol can use the stored BAT to complete fast on-line rate adaptation. Stored BATs are identified so that both the transmitter and receiver simply need to notify the other transceiver which table is being used without actually having to transmit the information redundantly. For example, the stored BATs may be numbered. The transmitter or receiver simply needs to tell the other transceiver which BAT table number is to be used for subsequent transmission. As with the NSRA method, either the receiver or the transmitter can initiate the FSRA protocol.

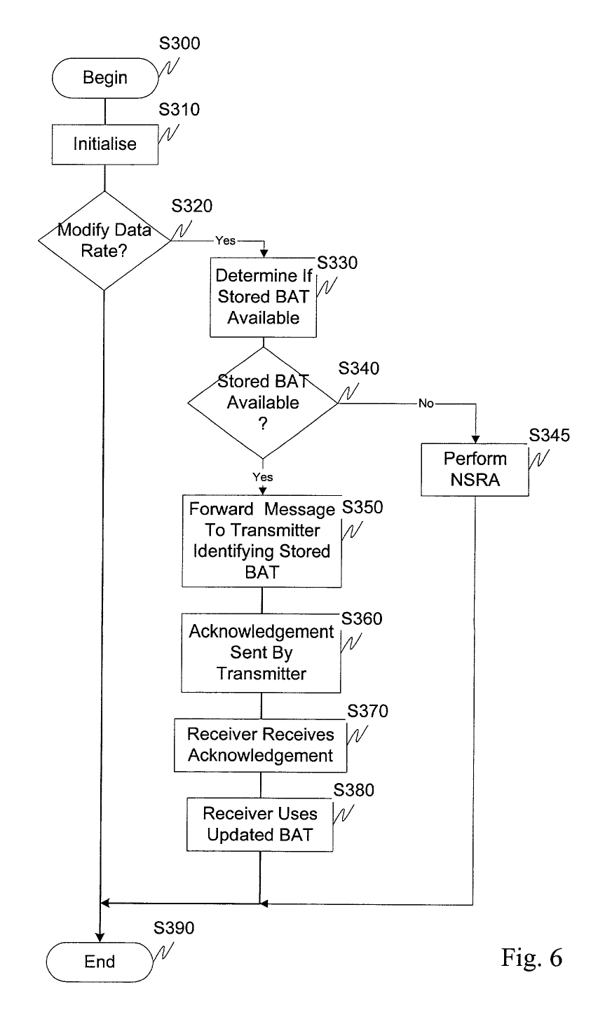

In particular, and with reference to FIG. 6, the receiver-initiated FSRA protocol commences in step S300 and continues to step S310. In step S310, initialization is completed. Next, in step S320, a determination is made whether the data rate should be modified. If the data rate is to be modified, control continues to step S330. Otherwise, control jumps to step S390, where the control sequence ends.

In step S330, the receiver attempts to locate a stored BAT matches the channel and/or application condition. Next, in step S340, a determination is made whether a stored BAT has been found that matches the conditions. If there is no stored BAT that matches the condition, control continues to step S345, where an NSRA is performed. Control then continues to step S390.

In step S350, if a BAT is found that matches the condition, the receiver sends a message to the transmitter specifying which stored BAT is to be used for transmission based on the new channel and/or application condition. This corresponds to an “FSRA Request” by the receiver. Next, in step S360, the transmitter receives the FSRA request and uses an inverted SYNC symbol as a flag to signal the receiver that the requested stored BAT will be used for transmission. The stored BAT is used for transmission on the first frame, or a finite number of frames, following the inverted SYNC symbol. The inverted SYNC symbol corresponds to a rate adaptation “SRA GO” message sent by the transmitter. Next, in step S370, the receiver detects the inverted SYNC symbol. Then, in step S380, the updated BAT is used for reception on the first frame, or for a finite number of frames, following the inverted SYNC symbol. Control then continues to step S390, where the control sequence ends.

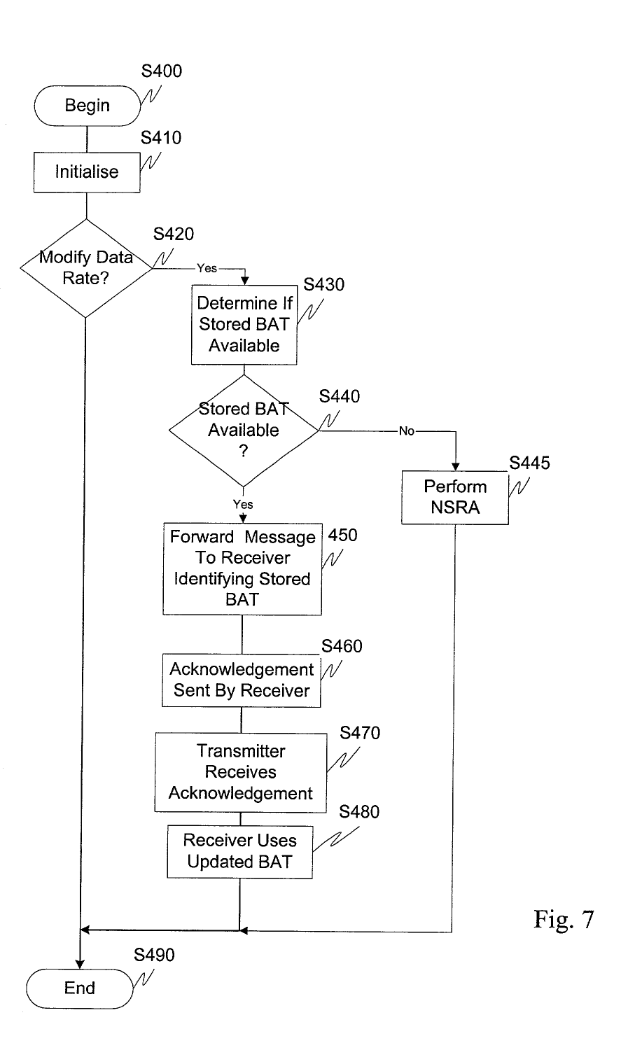

FIG. 7 illustrates a method of performing the fast seamless rate adaptive transmission bit rate changes which are transmitter initiated. In particular, control begins in step S400 and continues to step S410. In step S410, initialization is completed. Next, in step S420, a determination is made whether the data rate should be modified. If the data rate is to be modified which, for example, matches a channel and/or application condition, control continues to step S440. Otherwise, control jumps to step S490, where the control sequence ends.

In step S430, the transmitter attempts to locate a stored BAT matches the channel and/or application condition. Next, in step S440, a determination is made whether the stored BAT is available. If the stored BAT is not available, control continues to step S445 where the NSRA sequence is initiated. Control then continues to step S490.

However, in step S450, if a stored BAT matches the channel and/or application condition, the transmitter sends a message to the receiver specifying which stored BAT is to be used for transmission based on the channel and/or application condition. This corresponds to an FSRA request by the transmitter. Next, in step S460, the receiver receives the FSRA request and returns to the transmitter the FSRA Grant message to grant the FSRA request. Then, in step S470, the transmitter uses an inverted SYNC symbol as a flag to signal the receiver that the requested stored BAT will be used for transmission. Control then continues to step S480.

In step S480, the specified stored BAT is used for transmission on the first frame, or for a finite number of frames following the inverted SYNC symbol. The inverted SYNC symbol corresponds to a rate adaptation “SRA GO” message sent by the transmitter.

In step S480, the receiver detects the inverted SYNC symbol “SRA GO” and the stored BAT is used for reception on the first frame, or for a finite number of frames, following the inverted SYNC symbol.

The FSRA protocol can be completed very quickly. It only requires the exchange of two messages, i.e., the FSRA Grant and the FSRA Request and an inverted SYNC symbol. FSRA is faster than NSRA because, for example, the BAT is stored and need not be re-transmitted. As in the NSRA protocol, the FSRA protocol is also very robust in noisy environments since it uses an inverted SYNC symbol for the “SRA GO” message.

The seamless rate adaptive system and associated protocols also applies to DMT systems that implement dual (or multiple) latency paths. A dual latency system is defined in the ITU and ANSI standards as a DMT system that supports two data streams with different latency specifications in the Framer/FEC block.

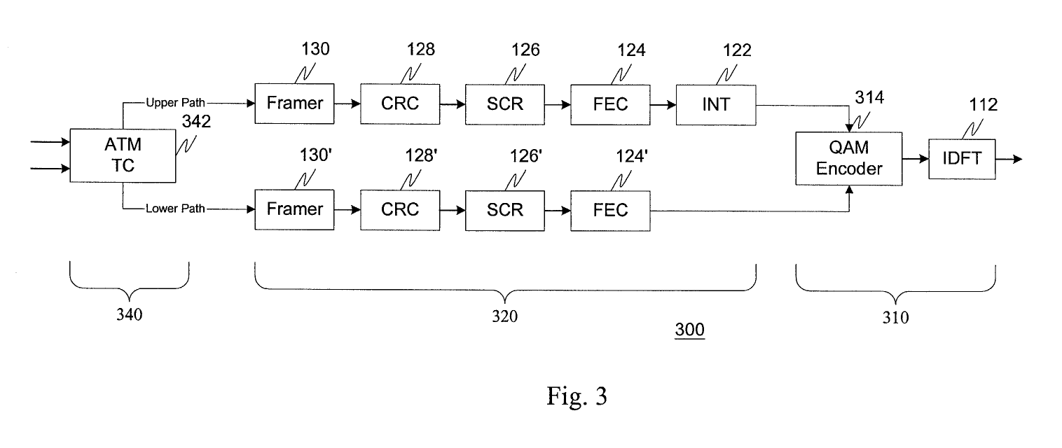

FIG. 3 illustrates a standard ADSL DMT system 300 that implements dual latency, as an example of a system having a plurality of latencies. The system 300 includes three layers: the Modulation layer 310, the Framer/FEC layer 320, and the ATM TC layer 340, which are similar but not identical to the three layers described above in relation to FIG. 1.

The Modulation layer 310 provides the functionality associated with the DMT modulation. The DMT modulation is implemented using a Inverse Discrete Fourier Transform (IDFT) 112. The IDFT 112 modulates the bits from the dual input Quadrature Amplitude Modulation (QAM) 314 encoder into the multicarrier subchannels. The operation of the Modulation layer 310 is analogous to that of Modulation layer 110 of FIG. 1, with the difference that the Modulation layer 310 has multiple inputs, rather than only one input.

The Framer/FEC layer 320 shown in FIG. 3 has two paths. This layer contains a first path that includes the same portions as in the Frame/FEC layer 120 of FIG. 1, namely the Interleaving (INT) portion 122, the Forward Error Correction (FEC) portion 124, the scrambler (SCR) portion 126, the Cyclic Redundancy Check (CRC) portion 128 and the ADSL Framer portion 130. The layer further contains a second path that includes a second one of each of the Forward Error Correction (FEC) portion 124′, the scrambler (SCR) portion 126′, the Cyclic Redundancy Check (CRC) portion 128′ and the ADSL Framer portion 130′. The Frame/FEC layer 320 provides functionality associated with preparing a stream of bits for modulation.

The lower path through the Framer/FEC layer 320 has a different amount of latency than the original upper path corresponding to FIG. 1, because the lower path does not perform interleaving on the data stream. Dual latency is used to send different application bit streams with different latency requirements through the ADSL DMT modem. As an example, an application that can tolerate high latency, e.g., video on demand, may be sent through the upper high latency path with interleaving, whereas the an application with low latency requirements, e.g., voice, may be sent through the lower low latency path without interleaving.

The ATM TC layer 340 includes an ATM TC portion 342 having multiple inputs and multiple outputs that transforms bits and bytes in cells into frames for each path.

The exemplary seamless rate adaptation system and method of the present invention also applies to a system with dual latency, or even multiple latencies. In the case of dual latency, the FEC and interleaving parameters for both paths are decoupled from the DMT symbol size. The BAT contains, in addition to the number of bits allocated to each subchannel, the data rate for each latency path in the form of bits per DMT symbol. When seamless rate adaptations are performed using the FSRA and NSRA protocols, the BAT also indicates the data rate for each latency path. For example, if the dual latency system runs with 1.536 Mbps on the interleaved path, e.g., a high latency upper path, and 256 kbps in the non-interleaved path, e.g., a low latency lower path, and an SRA is initiated, then the SRA protocol specifies the updated BAT containing the number of bits per subchannel and also the new data rate for each latency path. At a 4 kHz DMT symbol rate, a system running at 1.536 Mbps+256 kbps=1.792 Mbps. 1792000/4000=448 total bits per symbol. The BAT specifies that 1536000/4000=384 bits per symbol are allocated to the interleaved path and 256000/4000=64 bits per symbol are allocated to the non-interleaved path. In the example, when an SRA is performed, the updated data rate for the interleaved path can be 1.048 Mbps, i.e., 1048000/4000=262 bits per symbol, and the new data rate for the non-interleaved path can be 128 kbps, i.e., 128000/4000=32 bits per DMT symbol, resulting in a total throughput rate of 1.176 kbps, or 294 total bits per DMT symbol. The NSRA and FSRA protocols combined with the framing method specified herein complete this data rate change in both latency paths in a seamless manner.

It is also possible to not change the data rate on both latency paths. For example one may want to keep the 256 kbps low latency path at a constant data rate because it is carrying voice data, such as multiple telephone calls, that can not operate at a lower rate, whereas the 1.536 Mbps path may be carrying internet access data that can tolerate a rate change. In this example, during the SRA, the data rate of the low latency path is kept constant at 256 kbps whereas the data rate of the high latency path changes.

These basic concept can be expanded to encompass the transportation of a network timing reference (NTR) in an single or multiple latency ADSL DMT system. Specifically, the transportation of the NTR involves sending a timing reference signal from a CO modem to a CPE modem. This enables the CPE modem to reconstruct the network clock in order to send and receive signals or applications that are synchronous to the network clock, such as voice over DSL.

As discussed above, the framing layer is decoupled from the modulation layer. As a result, the NTR signal can not be inserted at the framing layer as is done in the current ADSL standards specified in the ITU and ANSI. Furthermore, the SRA enables the system to change the data rate on-line in a seamless manner by updating the total number of bits per DMT symbol. This is exactly what is necessary in order to transport the NTR since by using a subset of the subchannels to transport the NTR on a specific DMT symbol, the number of bits per DMT symbol is changing from one DMT symbol to another. The SRA methods discussed above allow this to happen seamlessly. However, it is to appreciated that the SRA enables the transport of the NTR regardless of whether the BAT is actually modified on the DMT symbol transporting the NTR, since the total number of bits per DMT symbol for the regular information data is changing from one DMT symbol to another.

Therefore, in accordance with an exemplary embodiment of this invention, the NTR signal is inserted and transported at the modulation layer by sending the NTR bits, for example, as specified in the ADSL standard, on a set of carriers of a specified DMT symbol in a superframe. For example, the NTR bits can be sent on the first DMT symbol of the superframe. Thus, for the other DMT symbols in the superframe, the set of carriers used for transporting the NTR can be used to transport other data, such as information data.

This versatility allows the same BAT to be used for the DMT symbol with the NTR bits and the DMT symbol without the NTR bits. However, a different BAT can be used for the DMT symbol that ends the NTR bits, than the DMT symbol(s) that do not send the NTR bits.

In the first case, or the DMT symbol with the NTR bits, a number of subchannels are used to transport the NTR bits, while for DMT symbols without NTR bits, these subchannels are used to transport other data, such as information data. For the second case, where the different BAT's are used, the use of different BATs can take advantage of sending the NTR bits with, for example, a higher margin than the regular information bits. This can be especially useful since, for example, the NTR signal may or may not be coded with the FEC coding scheme as the regular information bits.

As an example, during the DMT symbol that transports the NTR bits, the BAT in Table 2 can be used. During the DMT symbols without NTR bits, the BAT in Table 3 can be used. For example, during the DMT symbol that transports the NTR bits, the NTR signal is transmitted in a 4 bit message, as is done in the current ADSL standard, on subchannels 1, 3 and 6 with a high margin.

TABLE 2

| Subchannel Number | Bits Allocated to Subchannel |
|---|---|
| 1 | 1 (NTR) |
| 2 | 6 |
| 3 | 1 (NTR) |
| 4 | 5 |
| 5 | 4 |
| 6 | 2 (NTR) |
| 7 | 5 |
| 8 | 5 |
| 9 | 6 |
| 10 | 4 |
| 11 | 5 |
| | Total bits per symbol allocated to NTR = 4 |
| | Total bits per symbol allocated to regular |
| | information data = 40 |

When the NTR is not being sent, Table 3 illustrates that the BAT changed and that subchannels 1, 3 and 6 are used to transport information data.

TABLE 3

| Subchannel Number | Bits Allocated to Subchannel |
|---|---|
| 1 | 5 |
| 2 | 6 |
| 3 | 6 |
| 4 | 5 |
| 5 | 4 |
| 6 | 4 |
| 7 | 5 |
| 8 | 5 |
| 9 | 6 |
| 10 | 4 |
| 11 | 5 |
| | Total bits per symbol allocated to NTR = 0 |
| | Total bits per symbol allocated to regular |
| | information data = 55 |

While the above examples illustrate the use of subchannels 1, 3 and 6, it is to be appreciated that any subchannels, or combination thereof, can be used with equal success in accordance with the systems and methods of this invention.

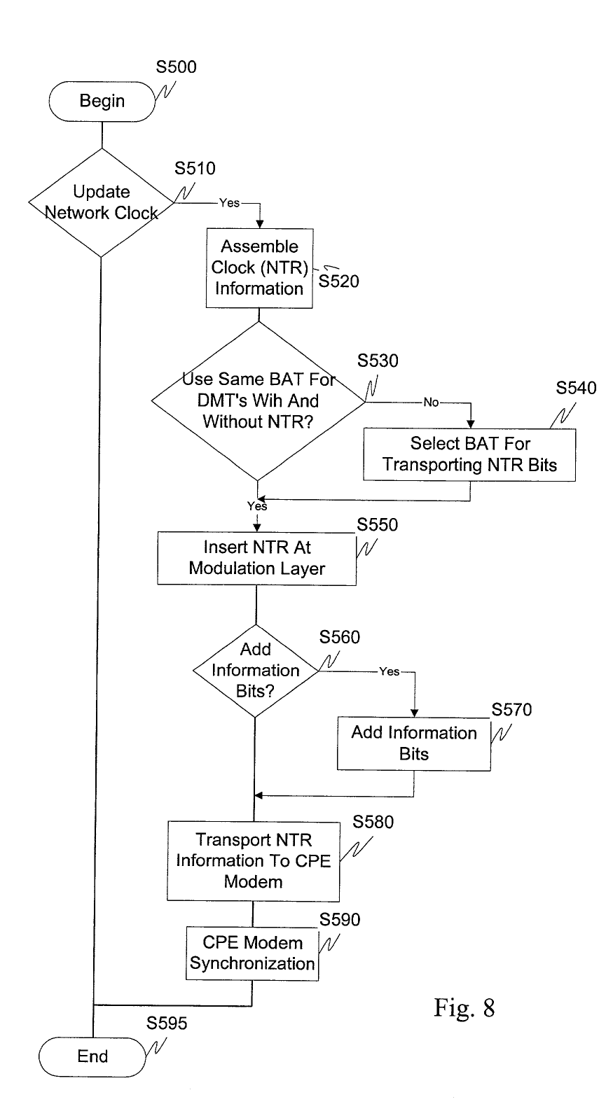

FIG. 8 illustrates an exemplary method of transporting an NTR from a CO modem to a CPE modem according to this invention. In particular, control begins in step S500 and continues to step S510, a determination is made wether to update the network clock. This update is typically done on a periodic basis, for example, every 69 DMT symbols, in order to allow the receiver to track the network clock using a timing recovery method, such as a phase loch loop. If the network clock is to be updated, control continues to step S520. Otherwise, control jumps to step S595 where the control sequence ends.

In step S520, the NTR information is assembled. Next, in step S530, a determination is made whether the same BAT is to be used for both the normal DMT symbols, i.e., those that do not contain the NTR bits, and the DMT symbols that are used for transmission of the NTR bits. If the same BAT is to be used, control jumps to step S550. Otherwise, control continues to step S540.

IN step S540, a BAT for use in transporting the NTR bits is selected. Control then continues to step S550. In step S550, the NTR is inserted at the modulation layer. This is done, for example, on the first DMT symbol of a superframe. Next, in step S560, a determination is made whether additional information bits are also to be added to the BAT. If additional information bits are to be added, control continued to step S570. Otherwise, control jumps to step S580. In most cases, additional information nits are added to the BAT. However, if the data rate is very low, then the NTR bits may be the only bits transmitted on that DMT symbol.

In step S570, the information bits are added to the BAT. Control then continues to step S580. In step S580, the NTR is transported to the CPE modem. Then, in step S590, the CPE modem receives the NTR and synchronizes the CPE clock. Control then continues to step S595 where the control sequence ends.

As illustrated in FIG. 1, the SRA with NTR system and related components can be implemented either on a DSL modem, such as an ADSL modem, or separate programmed general purpose computer having a communication device. However, the SRA with NTR system can also be implemented in a special purpose computer, a programmed microprocessor or a microcontroller and peripheral integrated circuit element, an ASIC or other integrated circuit, a digital signal processor, a hardwired or electronic logic circuit such as a discrete element circuit, a programmable logic device, such as a PLD, PLA, FPGA, PAL, or the like, and associated communications equipment. In general, any device capable of implementing the flowcharts illustrated in FIGS. 4-8 can be used to implement the SRA with NTR system according to this invention.

Furthermore, the disclosed method may be readily implemented in software using object or object-oriented software development environments that provide portable source code that can be used on a variety of computers, workstations, or modem hardware and/or software platforms. Alternatively, disclosed SRA with NTR system may be implemented partially or fully in hardware using standard logic circuits or a VLSI design. Other software or hardware can be used to implement the systems in accordance with this invention depending on the speed and/or efficiency requirements of this system, the particular function, and the particular software and/or hardware systems or microprocessor or microcomputer systems being utilized. The SRA with NTR system illustrated herein, however, can be readily implemented in a hardware and/or software using any known later developed systems or structures, devices and/or software by those of ordinary skill in the applicable art from the functional description provided herein and with a general basic knowledge of the computer and telecommunications arts.

Moreover, the disclosed methods can be readily implemented as software executed on a programmed general purpose computer, a special purpose computer, a microprocessor and associated communications equipment, a modem, such as a DSL modem, or the like. In these instances, the methods and systems of this invention can be implemented as a program embedded in a modem, such as a DSL modem, or the like. The SRA with NTR system can also be implemented by physically incorporating the system and method into a software and/or hardware system, such as a hardware and software system of a multicarrier information transceiver, such as an ADSL modem, VDSL modem, network interface card, or the like.

It is, therefore, apparent that there has been provided in accordance with the present invention, systems and methods for a SRA with NTR system. While this invention has been described in conjunction with a number of embodiments, it is evident that many alternatives, modifications and variations would be or are apparent to those of ordinary skill in the applicable art. Accordingly, applicants intend to embrace all such alternatives, modifications, equivalents and variations that are within the spirit and the scope of this invention.

What is claimed is:

1. A method for transporting a network timing reference comprising:
identifying a set of DMT symbols; and
associating, at a modulation layer, the network timing reference with a subset of the DMT symbols.

2. The method of claim 1, wherein information is associated with a second subset of the DMT symbols.

3. The method of claim 1, wherein the set of DMT symbols is capable of transmitting information when not associated with the network timing reference.

4. The method of claim 1, wherein a bit allocation table of the subset of DMT symbols associated with the network timing reference is different than a bit allocation table of the set of DMT symbols not associated with the network timing reference.

5. The method of claim 1, wherein a bit allocation table of the subset of DMT symbols associated with the network timing reference is the same as the bit allocation table of the set of DMT symbols not associated with the network timing reference.

6. The method of claim 1, wherein any one or more of a plurality of subchannels in a bit allocation table are capable of transporting the network timing reference.

7. The method of claim 6, wherein the subchannels used to transmit the network timing reference are sent with a higher margin than the subchannels used to transmit information.

8. An information storage media comprising information for transporting a network timing reference comprising:
information that identifyies a set of DMT symbols; and
information that associates, at a modulation layer, the network timing reference with a subset of the DMT symbols.

9. The media of claim 8, wherein information is associated with a second subset of the DMT symbols.

10. The media of claim 8, wherein the set of DMT symbols is capable of transmitting information when not associated with the network timing reference.

11. The media of claim 8, wherein a bit allocation table of the subset of DMT symbols associated with the network timing reference is different than a bit allocation table of the set of DMT symbols not associated with the network timing reference.

12. The media of claim 8, wherein a bit allocation table of the subset of DMT symbols associated with the network timing reference is the same as the bit allocation table of the set of DMT symbols not associated with the network timing reference.

13. The media of claim 8, wherein any one or more of a plurality of subchannels in a bit allocation table are capable of transporting the network timing reference.

14. The media of claim 13, wherein the subchannels used to transmit the network timing reference are sent with a higher margin than the subchannels used to transmit information.

15. A method of transporting a network timing reference comprising:
associating one or more network timing reference bits, at a modulation layer, on portion of one or more DMT symbols; and
transporting the one or more network timing reference bits to a modem.
